(19) United States
(12) Patent Application Publication
(10) Pub. No.: US 2004/0071917 A1
(43) Pub. Date: Apr. 15, 2004

(54) Multilayer label, receptacle comprising a multilayer label, and method for producing the multilayer label

(76) Inventor: Robert Unglert, Munchen (DE)

Correspondence Address: COLLARD & ROE, P.C., 1077 Northern Boulevard, Roslyn, NY, 11576-1696, US

(21) Appl. No.: 10/650,354

(22) Filed: Aug. 28, 2003

(30) Foreign Application Priority Data
Aug. 28, 2002 (DE) 102 39 510.1

(51) Int. Cl. B32B 9/00

(52) U.S. Cl. 428/40.1; 428/34.1

(57) ABSTRACT

A multilayer label comprises at least one bottom label (1) and a top label (2) which at least partly covers said bottom label (1). The bottom label (1), at its side facing away from the top label (2), comprises a first adhesive layer (3) for attaching the multilayer label to an object to be labelled, as well as a first non-adhesive region (4), such that a predominantly non-adhesive sheet is formed. The top label (2), at its side facing the bottom label (1), of which there is at least one, comprises a second adhesive layer (5) as well as a second non-adhesive region (6) such that a predominantly non-adhesive sheet is formed, wherein the first adhesive layer (3) at least partly overlaps the second adhesive layer (5), and wherein the top label comprises a section (7) which protrudes beyond the bottom label. The label is characterised by being easy and economical to produce.

The invention relates to a multilayer label comprising at least one bottom label and a top label which at least partly covers said bottom label.

A label of this type is known from EP 0 946 936 B1. The known label comprises a foil which can preferably be wrapped twice around a receptacle to be labelled. That part of the foil which directly rests against the receptacle is self-adhesive and comprises punched out areas which deliminate removable receipt sections. In order to prevent the removable receipt sections from permanently connecting to the receptacle, the foil in the region of the receipt sections is covered with an adhesive-rejecting piece of foil which is also self-adhesive. In order to produce such a design, two prepunched material webs have to be laminated together so that the registration marks fit exactly. After this, the composite layer has to be printed with a smooth layer and subjected to a renewed punch-out. Production is thus expensive.

In contrast, it is the object of the invention to provide a multilayer label which is simple to produce and which provides several pages that carry information.

This object is met by a multilayer label comprising at least one bottom label and a top label which at least partly covers said bottom label, wherein the bottom label, of which there is at least one, at its side facing away from the top label comprises a first adhesive layer for attaching the multilayer label to an object to be labelled, as well as a first non-adhesive region, such that a predominantly non-adhesive sheet is formed, wherein the top label at its side facing the bottom label, of which there is at least one, comprises a second adhesive layer as well as a second non-adhesive region such that a predominantly non-adhesive sheet is formed, wherein the top label comprises a section which protrudes beyond the bottom label.

The label design according to the invention provides for a label which is easy to produce. The top label and the bottom label are produced in parallel, preferably in a double web, in the customary way, wherein printing of the text can be controlled. After printing, punch-out and removal of the grid, the web is divided into two parts, with the top labels being applied to the bottom labels.

The region in which the first and the second adhesive layers are provided, in a sense constitutes the spine of a booklet, wherein the first adhesive layer on the lower or lowermost label ensures connection of the booklet to the object to be labelled. The non-adhesive regions on the top label and the bottom label or the bottom labels form the sheets of the booklet, with said sheets being able to be printed on both sides. In the non-adhesive region of the top label, on the margin, an attachment means in the form of a small quantity of adhesive can be provided so as to be able to close the booklet. Nevertheless, after the booklet has been opened, the sheet can be moved freely. The expression “predominantly non-adhesive” as used in claim 1 is to be interpreted in this sense.

According to an advantageous embodiment, the bottom label, of which there is at least one, on its side facing the top label, comprises a first adhesive-rejecting layer. In this instance, and in the text below, the term “adhesive rejecting layer” refers to a surface to which a part which is coated with pressure sensitive adhesive adheres temporarily, while said surface can be peeled off this adhesive-rejecting layer without significantly impairing the adhesive properties of the pressure sensitive adhesive and without damaging the adhesive-rejecting layer. Frequently, silicon materials and lacquers are used for producing adhesive-rejecting layers. The adhesive-rejecting layers can be homogeneous over their entire surface region, or, for the purpose of setting their release behaviour they can be designed in the form of a grid or dot-point pattern. Providing indentations or recesses at the margin of the layer can provide a particular rigidity of the connection to the part coated with pressure sensitive adhesive. The adhesive-rejecting layer serves to provide an arrangement where the connection between the top label or parts thereof and the bottom label is releasable so that if required the top label or parts thereof can be removed from the bottom label and can be stuck to another location. Depending on the application, it may be provided for the entire adhesive surface of the removable part to contact the adhesive-rejecting layer, thus providing particularly easy release. However, it is also possible to provide the adhesive-rejecting layer in a size which is smaller than the size of the adhesive surface of the releasable part. In this way, the margin of said releasable part adheres to a foil surface or a layer made of printing ink or the like, establishing a comparatively firm connection with said foil surface or layer made of printing ink. This prevents the margins of the releasable part from becoming undesirably detached from the substrate.

The multilayer label according to the invention can be attached to objects of any desirable shape. However, a particularly advantageous improvement of the invention provides for the length of the bottom label, of which there is at least one, and the length of the top label to be such as to make possible a self-overlapping arrangement on a cylindrical receptacle. In this arrangement, first the region of the first adhesive layer of the bottom label establishes contact with the receptacle and establishes a firm connection with said receptacle. First, the non-adhesive regions, which constitute the sheets of the booklet, are loosely wrapped around the receptacle until the protruding section of the top label comes to rest against part of the top label where it establishes a temporary but firm connection with the top label, so that the booklet is closed and the entire multilayer label is firmly connected to the receptacle.

Advantageously, a second adhesive-rejecting layer is provided in the position where the protruding section of the top label rests against said top label, with said second adhesive-rejecting layer facilitating release of the protruding section and thus facilitating detachment of the protruding section and thus opening of the booklet.

According to a preferred embodiment of the invention, the top label comprises punch-outs in the region of the second adhesive layer, with said punch-outs being arranged such that they create at least one removable receipt section. Punch-outs in this sense refers to lines which weaken materials, or to separation lines of all kinds, in particular also including perforations or separation lines aligned in parallel, with the material being spaced apart between the two separation lines, as well as to combinations of the above-mentioned measures. These receipt sections, which as a result of the second adhesive layer are self-adhesive, can easily be detached and for example be stuck into a documentation book. Easy release is provided by the presence of the first adhesive-rejecting layer on the bottom label. Thus, the bottom label not only serves as a sheet of the booklet but also as a carrier for the releasable attachment of the receipt section or of the receipt sections which in the state of the art necessitated two different components.

The invention also relates to a receptacle comprising a multilayer label.

According to a preferred embodiment, the length of the label in the direction of the tape run is greater than the circumference of the receptacle.

According to a further preferred embodiment, the circumference is however smaller than double the circumference of the receptacle.

Furthermore, the invention also relates to a method for producing a multilayer label. According to this method, the top labels and the bottom labels are prepared in parallel; thereafter the top labels are applied to the bottom labels. This results in significant simplification and cost reduction when compared to the known state of the art.

Below, the invention is explained in more detail with reference to embodiments which are diagrammatically shown in the Figures. The drawings are not to scale. In particular, for the sake of clarity, the layer thicknesses are excessive when compared to the longitudinal extension of the layers. In this document, the term “bottom” refers to that side of the label which according to the intended use faces an object to which the label is attached. Correspondingly, “top” refers to that side of the label which according to the intended use faces away from the object to be labelled.

The drawings show the following:

FIG. 1: a longitudinal section of the first embodiment of the multilayer label according to the invention;

FIG. 2: a top view of the top label of the multilayer label according to the invention;

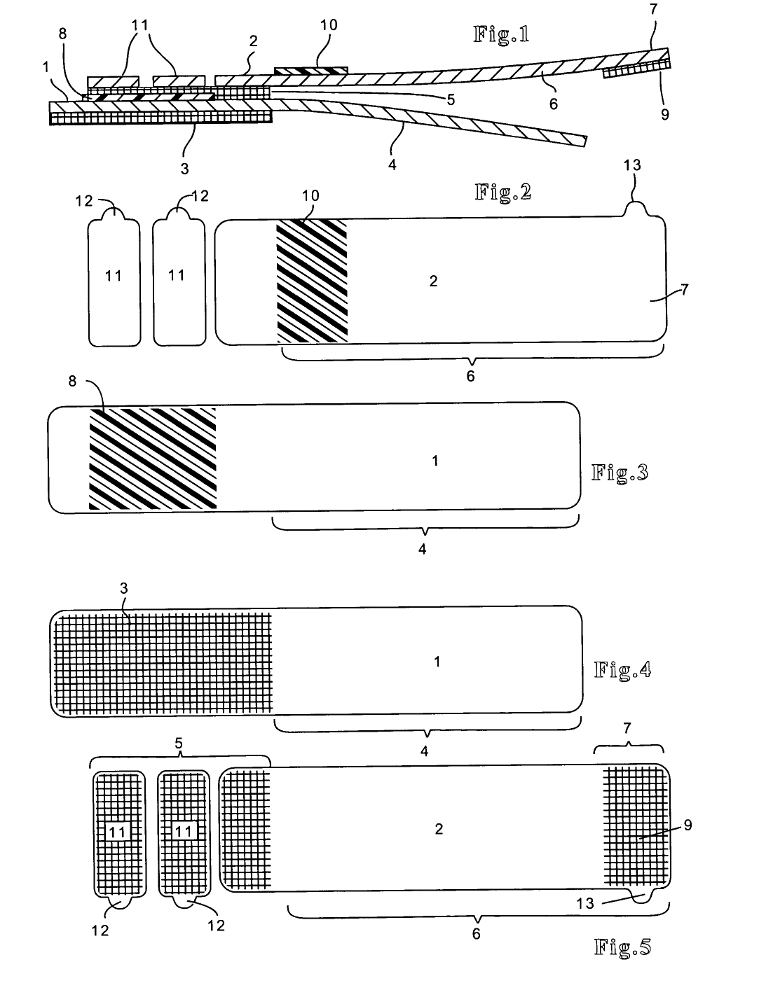

FIG. 3: a top view of the bottom label of the multilayer label according to the invention;

FIG. 4: a view from below of the bottom label of the multilayer label according to the invention;

FIG. 5: a view from below of the top label of the multilayer label according to the invention;

FIG. 6: a top view of the multilayer label which is comprised of the top label and bottom label; and

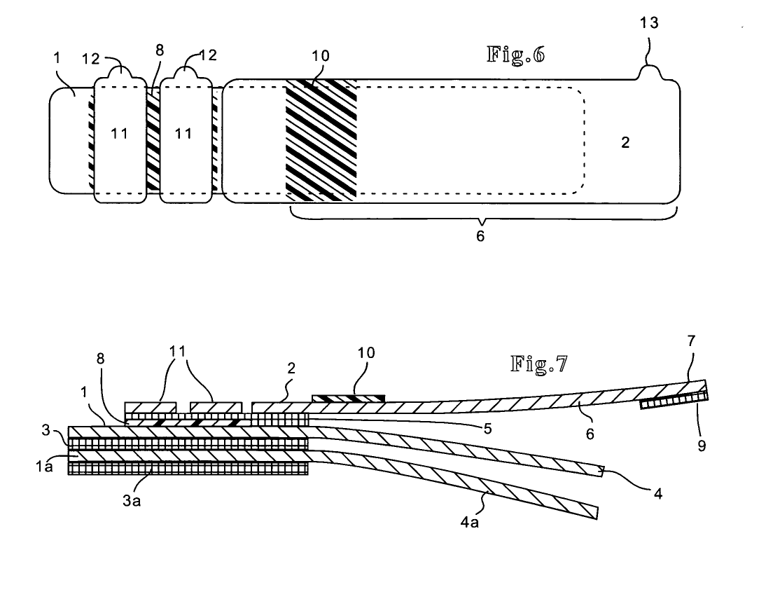

FIG. 7: a longitudinal section of a second embodiment of the label according to the invention, which label comprises a total of three layers.

FIG. 1 shows a longitudinal section of a first embodiment of the multilayer label according to the invention. Reference number 1 refers to a bottom label which comprises a layer made of paper or plastic. At its underside, the bottom label 1 comprises a first adhesive layer 3 by means of which it can for example be attached to a receptacle to be labelled. Apart from this, the bottom label comprises no further adhesive layers; in particular a first non-adhesive region 4 is provided which forms a sheet. This sheet, which at its top and/or its underside can contain printed information, is freely movable and can be turned over in the manner of a page in a booklet so that both sides can be viewed. The top of the bottom label comprises a first adhesive-rejecting layer 8 opposite the adhesive layer 3.

Above the bottom label 1 there is a top label 2 which comprises a layer made of paper or plastic. At its underside, the top label 2 comprises a second adhesive layer 5 by means of which it is firmly connected to the bottom layer 1 while also covering the first adhesive-rejecting layer 8 of the bottom label 1. At the opposite end of the top label 2, said top label 2 protrudes beyond the bottom label 1 by the distance of section 7. In the region of section 7, the underside of the top label 2 comprises an adhesive layer 9 which serves as an attachment means. Apart from this, the top label does not comprise any further adhesive layers, in particular, a second non-adhesive region 6 is provided which forms a sheet. This sheet, which at its top and/or underside can contain printed information, is freely movable and can be turned over in the manner of a page in a booklet so that both sides can be viewed.

The non-adhesive regions of the top label and of the bottom label cover each other so that they form two sheets of a booklet, comprising four pages containing written information, while the first and the second adhesive layers 3 and 5 are located at the opposite end, in a sense constituting the spine of the booklet.

Furthermore, the top of the top label comprises a second adhesive-rejecting layer 10, whose dimensions approximately correspond to those of the adhesive layer 9.

In the region of the first adhesive-rejecting layer 8, which is covered by the second adhesive layer 5, the top label 2 is divided by two transverse punch-outs, so that two detachable receipt labels 11 are formed. Although in the present example the punch-outs are guided such that the receipt labels are completely separated, they remain safely in their respective locations as they adhere to the first adhesive-rejecting layer 8 of the bottom label 1 as a result of the effect of the second adhesive layer 5. Unlike in the example just described, it would also be possible to carry out only one perforation punch-out, so that the receipt labels 11 would have to be torn off along a roulette line.

The example just described provides for the second adhesive layer 5 not only to cover the first adhesive-rejecting layer 8 of the bottom label 1 but also to protrude beyond said first adhesive-rejecting layer 8, so that a firm and lasting adhesive connection is established between the top label 2 and the bottom label 1. Unlike this arrangement, it is also possible to design the first adhesive-rejecting layer 8 of the bottom label 1 to be larger, so that the second adhesive layer 5 of the top label 2 is completely supported by the first adhesive-rejecting layer 8 of the bottom label 1. In this case, all of the top label would only be loosely connected to the bottom label and could conveniently be separated from said bottom label, so as to stick it to another position.

FIG. 2 shows a top view of the top label 2 of the multilayer label according to the invention. The top label 2 is approximately rectangular. Two receipt sections 11 have been separated by means of transverse punch-outs. Reference number 10 designates the second adhesive-rejecting layer which has already been described above. The longitudinal direction of the rectangle is identical to the direction in which the machine runs when production is by machine.

FIG. 2 shows that an approximately semicircular tab 12 is arranged on each of the two removable receipt sections 11, with these tabs providing a convenient grip of the receipt section. A similar tab 13 has been provided on the longitudinal extension of section 7. This tab 13 too provides an easy grip of the sheet which is formed by the top label 2, for the purpose of opening the booklet.

With the proviso that in the region of section 7 a smaller adhesive layer 9 has been provided, section 6 is free of adhesive, thus representing a sheet which can be turned over in the manner of a page in a booklet, with the two sides of said sheet serving as information carriers.

FIG. 3 shows a top view of the bottom label 1 of the multilayer label according to the invention. The bottom label 1 is approximately rectangular; it is somewhat narrower than the top label 2. Reference number 8 designates the first adhesive-rejecting layer 8 which has already been described. Reference number 4 relates to the non-adhesive first region which represents the second sheet of the booklet, which sheet can be turned over in the manner of a page.

FIG. 4 shows a view from below of the bottom label 1 of the multilayer label according to the invention. The first adhesive layer 3 and the first non-adhesive region 4 are shown.

FIG. 5 shows a view from below of the top label 2 of the multilayer label according to the invention. The second adhesive layer 5 is shown which extends across the two removable receipt sections 11 as well as across part of the remaining top labels. Furthermore, section 6, which is predominantly non-adhesive, is shown, which apart from the adhesive layer 9 in section 7 is non-adhesive. The tabs 12 of the receipt sections 11 as well as the protruding tab 13 for gripping are non-adhesive, so as to prevent the user establishing contact with adhesive when touching the tab.

FIG. 6 shows a top view of the multilayer label comprised of top label 2 and bottom label 1. The outline of the bottom label 1 that is covered by the top label 2 is indicated by a dashed line. In the embodiment shown, the bottom label is somewhat narrower than the top label. The bottom label may also be of the same width as, or larger than, the top label.

FIG. 7 shows a longitudinal section of a second embodiment of the label according to the invention, which label comprises a total of three layers. In the second embodiment, shown in FIG. 7, two identical bottom labels 1 and 1a are provided which both comprise an adhesive layer 3 and 3a respectively. The adhesive layer 3 serves to establish a connection between the bottom labels 1 and 1a, while the adhesive layer 3a serves to connect the entire label structure with an object to be labelled. Apart from this, the design of the label is identical to that shown in FIG. 1. The provision of the further bottom label 1a results in a booklet comprising a total of three sheets, i.e. six information pages. It goes without saying that embodiments comprising still more bottom labels are also possible.

While according to the state of the art several receipt sections were applied in several application procedures, according to the invention practically any desired number of receipt sections can be applied in a single application procedure. The method is as follows:

The bottom labels 4 are arranged on a first carrier web (not shown) which is adhesive-rejecting and runs in longitudinal direction. A second carrier web (not shown) carries the top labels 6 in the same way, including the receipt sections 11. The second carrier web, which is arranged above the first carrier web, runs synchronously in relation to the first carrier web so that the registration marks fit exactly, and is drawn over a deflection edge having a small radius of curvature, so that the top labels, including the receipt sections, which are arranged on said second carrier web, do not follow the curvature during deflection, but instead are lifted off the carrier web. Since the deflection edge is arranged in close proximity to the surface of the first carrier web, the adhesive layers 5 of the top labels 6 which are lifted off the second carrier web reach the bottom labels 4 against which they are continuously pressed by a roller (not shown). This results in the composite label shown in FIGS. 1 and 7 respectively, which composite label is arranged on the first carrier web. According to the invention, a top label with theoretically any number of individual components (receipt sections 11) can be applied to a bottom label in only one single application device in one single procedure. Irrespective of the number of components which make up the top label, the equipment-related expenditure and work-related expenditure during adjustment of the machine to achieve infeed of the top label, so that the registration marks fit exactly, only occurs once.

The label according to the invention is used as follows for labelling a receptacle:

As a rule, the labels are arranged on a carrier web (not shown) which comprises a smooth adhesive-rejecting layer. The direction of movement of the carrier strip is parallel to the longitudinal direction of the label. The labels are arranged on the carrier strip such that the regions with the adhesive layers 3 and 5 are in front, in the direction of movement. The carrier strip is then according to a known technique drawn over a separation edge comprising a small radius of curvature, with said separation edge effecting separation between the carrier strip and the label. The label which continues to move straight on beyond the separation edge establishes contact with a rotating cylindrical receptacle, after which the adhesive layer 3 (in the embodiment according to FIG. 7 the adhesive layer 3a) establishes a connection with the outside surface of the receptacle.

Since the length of the label is greater than the circumference of the receptacle, as the receptacle continues to rotate, the label is applied around the outside surface of the receptacle. At the second rotation of the receptacle, the non-adhesive regions come to rest on the receipt sections 11. Finally, the adhesive layer 9 is applied to the second adhesive-rejecting layer 10, establishing an adequate connection with said adhesive-rejecting layer 10, so that the label is firmly attached to the receptacle.

Although the receipt sections 11 are covered up by the label, the presence of the receipt section is clearly obvious to the end user since the tabs 12 of said receipt sections protrude beyond the edge of the label.

In order to access the information contained on the inner sheets of the label, the end user holds the top label 2 at the protruding tab 13 for gripping, and lifts the section 7 with its adhesive layer 9 from the second adhesive-rejecting layer 10. The non-adhesive regions, or more precisely the predominantly non-adhesive regions 4 and 6, can then be unrolled from the receptacle and can be freely unfolded. At this point, the receipt sections 11 are also free; if required they can be lifted off the first adhesive-rejecting layer. After this, they can for example be stuck into a documentation book or onto a syringe. After the end user has studied the contents of the booklet which comprises the top label 2 and the bottom label 1, and if necessary after removal of one of the receipt labels 11, the end user wraps the top label 2 and the bottom label 1 around the receptacle again. Finally, the adhesive layer 8 is reconnected to the second adhesive-rejecting layer 10 in that said adhesive layer 8 is pressed with a finger against said second adhesive-rejecting layer 10.

1. A multilayer label comprising at least one bottom label (1) and a top label (2) which at least partly covers said bottom label (1), wherein the bottom label (1), of which there is at least one, at its side facing away from the top label (2) comprises a first adhesive layer (3) for attaching the multilayer label to an object to be labelled, as well as a first non-adhesive region (4), such that a predominantly non-adhesive sheet is formed, wherein the top label (2), at its side facing the bottom label (1), of which there is at least one, comprises a second adhesive layer (5) as well as a second non-adhesive region (6) such that a predominantly non-adhesive sheet is formed, wherein the top label comprises a section (7) which protrudes beyond the bottom label.

2. The multilayer label according to claim l, in which the first adhesive layer (3) at least partly overlaps the second adhesive layer (5).

3. The multilayer label according to claim 1, in which the protruding section (7) is arranged at the margin of the second non-adhesive region (6).

4. The multilayer label according to claim 1, in which the bottom label (1), of which there is at least one, at its side facing the top label (2) comprises a first adhesive-rejecting layer (8).

5. The multilayer label according to claim 4, in which the first adhesive-rejecting layer (8) of the bottom label (1), of which there is at least one, overlaps the first adhesive layer (3).

6. The multilayer label according to claim 1, in which the protruding section (7) of the top label (2) comprises attachment means (9) for detachable attachment.

7. The multilayer label according to claim 1, in which the length of the bottom label (1), of which there is at least one, and of the top label (2) is such that a self-overlapping arrangement on one receptacle is possible.

8. The multilayer label according to claim 7, in which the top label (2) at its side facing away from the bottom label (1) comprises a second adhesive-rejecting layer (10).

9. The multilayer label according to claim 1, in which the top label (2) comprises punch-outs in the region of the second adhesive layer (5), with said punch-outs being arranged such that they create at least one detachable receipt section (11).

10. The multilayer label according to claim 9, in which the punch-outs completely separate the top label (2).

11. The multilayer label according to claim 10, in which the punch-outs are two stamping lines, aligned one beside the other, with a gap which is free of material resulting between the stamping lines, so that the receipt sections are free-standing.

12. The multilayer label according to claim 9, in which the punch-outs of the top label (2) are perforations.

13. The multilayer label according to claim 9, in which a protruding tab (12) is arranged on the receipt section (11), of which there is at least one.

14. The multilayer label according to claim 1, in which a protruding tab (13) for gripping is arranged on the top label.

15. The multilayer label according to claim 1, in which the second adhesive layer (5) comprises a surface area which approximately agrees with the surface area of the first adhesive layer (3), wherein the first and the second adhesive layers are arranged so that one covers the other.

16. The multilayer label according to claim 1, in which the first adhesive layer (3) and the second adhesive layer (5) have been created by means of selective application of adhesive.

17. The multilayer label according to claim 1, in which the first adhesive layer (3) and the second adhesive layer (5) have been created in that a foil, which is completely coated with adhesive, is selectively treated with a means which locally cancels out the adhesive force of the adhesive.

18. A receptacle comprising a multilayer label, with said label comprising the following:
at least one bottom label (1) and a top label (2) which at least partly covers said bottom label (1), wherein the bottom label (1), of which there is at least one, at its side facing away from the top label (2) comprises a first adhesive layer (3) for attaching the multilayer label to the receptacle, as well as a first non-adhesive region (4), such that a predominantly non-adhesive sheet is formed, wherein the top label (2) at its side facing the bottom label (1), of which there is at least one, comprises a second adhesive layer (5) as well as a second non-adhesive region (6) such that a predominantly non-adhesive sheet is formed, wherein the first adhesive layer (3) at least partly overlaps the second adhesive layer (5), and wherein the top label comprises a section (7) which protrudes beyond the bottom label.

19. The receptacle comprising a multilayer label according to claim 18, in which the length of the multilayer label is greater than the circumference of the receptacle.

20. The receptacle according to claim 19, in which the length of the multilayer label is greater than twice the circumference of the receptacle.

21. A method for producing the multilayer label according to claim 1, comprising the following steps (not necessarily in the order selected):
a) Providing an adhesive-rejecting carrier web;
b) Local printing of the carrier web with adhesive killer;
c) Printing text and motives onto a foil web;
d) If applicable, local printing, with an adhesive-rejecting material, of the foil web;
e) Laminating the printed carrier web together with the foil web;
f) Punching out the foil web to form labels, and removing the remaining grid;
g) Separating the material web into a label web for bottom labels and a label web for top labels; and
h) Applying the top labels to the bottom labels.

22. The method for producing the multilayer label according to claim 1, comprising the following steps (not necessarily in the order selected):
a) Providing an adhesive-rejecting first carrier web and an adhesive-rejecting second carrier web;
b) Local printing of the first and second carrier web with adhesive killer;
c) Printing text and motives onto a foil web for bottom labels;
d) If applicable, local printing, with an adhesive-rejecting material, of the foil web for bottom labels;
e) Laminating the printed first carrier web together with the foil web for bottom labels;
f) Punching out the foil web for bottom labels to form labels, and removing the remaining grid;
g) Printing text and motives onto a foil web for top labels;
h) If applicable, local printing, with an adhesive-rejecting material, of the foil web for top labels;
i) Laminating the printed second carrier web together with the foil web for top labels;
j) Punching out the foil web for top labels to form labels, and removing the remaining grid; and
k) Applying the top labels to the bottom labels.

23. The method for producing the multilayer label according to claim 1, comprising the following steps (not necessarily in the order selected):
a) Printing text and motives onto a foil web;
b) If applicable, local printing, with an adhesive-rejecting material, of the foil web;
c) Local coating of the foil web with adhesive;
d) Providing an adhesive-rejecting carrier web;
e) Laminating the carrier web together with the foil web;
f) Punching out the foil web to form labels, and removing the remaining grid;
g) Separating the material web into a label web for bottom labels and a label web for top labels; and
h) Applying the top labels to the bottom labels.

24. The method for producing the multilayer label according to claim 1, comprising the following steps (not necessarily in the order selected):
a) Printing text and motives onto a foil web for top labels;
b) If applicable, local printing, with an adhesive-rejecting material, of the foil web for top labels;
c) Local coating of the foil web for top labels with adhesive;
d) Printing text and motives onto a foil web for bottom labels;
e) If applicable, local printing, with an adhesive-rejecting material, of the foil web for bottom labels;
f) Local coating of the foil web for bottom labels with adhesive;
g) Providing a first and a second adhesive-rejecting carrier web;
h) Laminating the first and second carrier webs together with the foil web for top labels and the foil web for bottom labels respectively;
i) Punching out the foil web for top labels and the foil web for bottom labels to form labels, and removing the remaining grid; and
j) Applying the top labels to the bottom labels.
